(19) United States
(12) Patent Application Publication
(10) Pub. No.: US 2019/0193740 A1
(43) Pub. Date: Jun. 27, 2019

(54) METHOD AND SYSTEM OF PREVENTING AUTOMATIC TRANSMISSION VEHICLE FROM ROLLING DOWNWARD ON HILL

(71) Applicants: Hyundai Motor Company, Seoul (KR); Kia Motors Corporation, Seoul (KR)

(72) Inventor: Jin Han, Bucheon (KR)

(21) Appl. No.: 16/142,307

(22) Filed: Sep. 26, 2018

(30) Foreign Application Priority Data
Dec. 27, 2017 (KR) 10-2017-0181459

(51) Int. Cl. B60W 30/18; B60W 40/076; B60T 7/12; B60T 8/171; B60T 8/58

(52) U.S. Cl. CPC B60W 30/18172; B60T 2210/20; B60W 30/18118; B60W 40/076; B60T 7/122; B60T 8/171; B60T 8/58; B60W 2520/06; B60W 2520/263; B60W 2520/28; B60W 2540/12; B60W 2550/142; B60T 2201/06; B60T 2201/10; B60T 2240/00; B60W 30/18027

(57) ABSTRACT

A method of preventing an automatic transmission vehicle from rolling downward on a hill is provided. The method includes determining whether the vehicle travels normally or abnormally on the hill based on a gradient measured by a G sensor and a direction of a wheel measured by a wheel sensor. A controller is maintained in an off state when the vehicle travels normally based on driver intention. The method further includes determining whether to operate the controller by determining a difference in wheel speed between a front wheel and a rear wheel of the vehicle when the vehicle travels abnormally as the vehicle rolls downward.

### CROSS-REFERENCE TO RELATED APPLICATIONS

This application claims priority under 35 U.S.C. § 119 to Korean Patent Application No. 10-2017-0181459, filed on Dec. 27, 2017, the disclosure of which is incorporated herein by reference in its entirety.

### BACKGROUND

### 1. Field of the Invention

The present invention relates to a method and system of preventing an automatic transmission vehicle from rolling downward on a hill, and particularly, to a method of preventing an automatic transmission vehicle from rolling downward on a hill by using a sensor installed in the vehicle when inhibitor switch is defective.

### 2. Description of the Related Art

When a driver stops a vehicle and then starts the vehicle on a hill (e.g., inclined road), the driver disengages a brake pedal and then engages an accelerator pedal. In particular, when driving power is insufficient, the rolling back of the vehicle occurs since the vehicle rolls downward on the hill.

Therefore, a hill-start assist control (hereinafter, referred to as ′HAC′) has been developed, which prevents the vehicle from rolling downward by producing and providing braking force to respective vehicle wheels using a brake device when starting the vehicle stopped on the hill. The HAC is configured to recognize a hill, apply braking force to the respective vehicle wheels until a power device of the vehicle generates driving torque to the extent that the vehicle does not roll downward when the driver engages the accelerator pedal on the hill, and releases the braking force. The HAC operates in a state in which the vehicle is stopped and in a brake off state in which the driver disengages the brake pedal.

In this regard, the related art discloses a control apparatus and a control method for preventing a vehicle from rolling downward on a hill, which are capable of reducing a likelihood of a rear-end collision of a vehicle and improving safety by controlling pressure of a master cylinder by using an ultrasonic sensor through a wheel speed sensor configured to measure a speed of the vehicle, a detecting sensor, and a controller when an acceleration sensor breaks down.

The related art uses the pressure and the ultrasonic sensor for preventing the rolling down of the vehicle, but the related art does not disclose a case in which an inhibitor switch is defective and thus cannot recognize gear shift stages. In other words, the related are is unable to recognize the gear shift stages of a transmission (TM), such that an electronic stability control (ESC) recognizes this situation as an uncontrollable situation, and as a result, there is still a problem in that lamps related to a system stop, warning, and the like are turned on.

### SUMMARY

The present invention provides a system and method of preventing an automatic transmission vehicle from rolling downward on a hill, which are capable of preventing the vehicle from rolling downward even when an inhibitor switch is defective and thus unable to recognize gear shift stages.

An exemplary embodiment of the present invention provides a method of preventing an automatic transmission vehicle from rolling downward on a hill, which operates a controller configured to prevent the vehicle from rolling downward by using a G sensor and a wheel sensor mounted within the vehicle. The method may include: determining whether the vehicle travels normally or abnormally on the hill based on a gradient measured by the G sensor and a direction of a wheel measured by the wheel sensor; and allowing the controller not to operate when the vehicle travels normally based on a driver's intention and determining whether to operate the controller by determining a difference in wheel speed between a front wheel and a rear wheel of the vehicle when the vehicle abnormally travels as the vehicle rolls downward.

The controller may be configured to operate regardless of an inhibitor switch installed in the vehicle. The method may further include determining, by the G sensor, whether the vehicle is on an uphill road or a downhill road; and determining, by the wheel sensor, any one of a clockwise direction of the wheel, a counterclockwise direction of the wheel, and a stop of the wheel. Additionally, the method may include determining, by the G sensor, whether the vehicle is on an uphill road or a downhill road; and determining, by the wheel sensor, any one of a forward direction of the wheel, a rearward direction of the wheel, and a stop of the wheel.

The method may include: allowing the controller not to operate by determining that the vehicle travels normally when a gradient measured by the G sensor is uphill and the wheel moves forward or stops; and determining whether to operate the controller by determining that the vehicle travels abnormally when a gradient measured by the G sensor is uphill and the wheel moves rearward and by determining a difference in wheel speed between the front wheel and the rear wheel of the vehicle. The method may include: allowing the controller not to operate by determining that the vehicle travels normally when a gradient measured by the G sensor is downhill and the wheel moves rearward or stops; and determining whether to operate the controller by determining that the vehicle travels abnormally when a gradient measured by the G sensor is downhill and the wheel moves forward and by determining a difference in wheel speed between the front wheel and the rear wheel of the vehicle.

Further, the method may include determining a difference in wheel speed between the front wheel and the rear wheel of the vehicle when the vehicle travels abnormally, in which the difference in wheel speed is determined after the vehicle stops and then a brake pedal is released. The controller may be any one of a hill-start assist control (HAC), an electronic parking brake (EPB), and an automatic vehicle hold (AVH) which are installed in the vehicle.

According to the present invention, the inhibitor switch, which generates unstable signals, is not used for logic for driving the controller, and as a result, it may be possible to address unsatisfactory performance incurred to customers due to the occurrence of warning related to an electronic stability control (ESC) system or the like. In addition, the present invention may improve a performance of the ESC system and operate related controllers such as an automatic vehicle hold (AVH), an electronic parking brake (EPB), and a hill-start assist control (HAC) by using devices which are already mounted within the vehicle, and as a result, it may be possible to control the vehicle without an increase in costs.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates an apparatus and a sequence for determining a method of preventing an automatic transmission vehicle from rolling downward on a hill according to an exemplary embodiment of the present invention; and

FIG. 2 is a flowchart of the method of preventing an automatic transmission vehicle from rolling downward on a hill according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, the present invention will be described in detail with reference to the accompanying drawings. However, the present invention is not restricted or limited by exemplary embodiments. Like reference numerals indicated in the respective drawings refer to members which perform substantially the same functions.

An object and an effect of the present invention may be naturally understood or may become clearer from the following description, and the object and the effect of the present invention are not restricted only by the following description. In addition, in the description of the present invention, the specific descriptions of publicly known technologies related with the present invention will be omitted when it is determined that the specific descriptions may unnecessarily obscure the subject matter of the present invention.

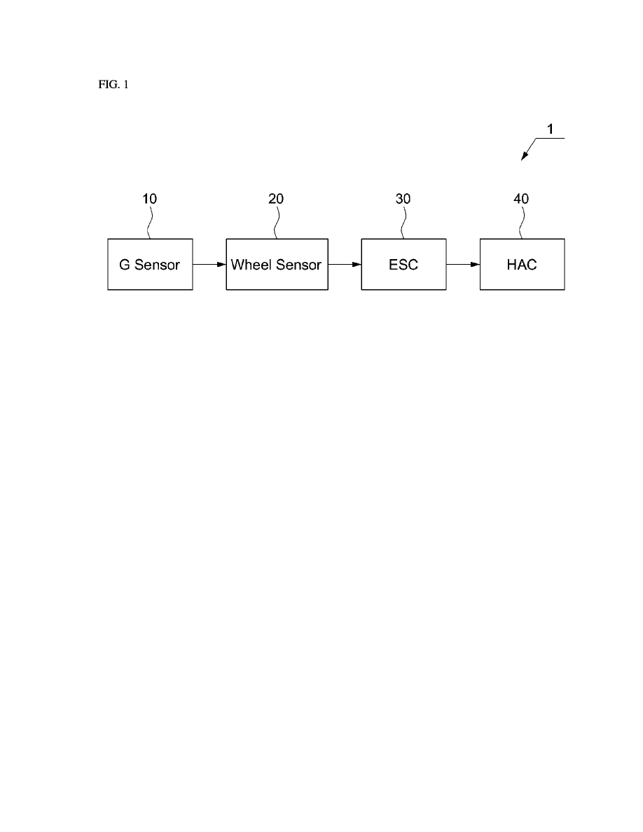

FIG. 1 illustrates an apparatus 1 and a sequence for determining a method of preventing an automatic transmission vehicle from rolling downward on a hill according to an exemplary embodiment of the present invention. Referring to FIG. 1, the apparatus 1 for determining the method of preventing a vehicle from rolling downward on a hill according to the present invention may include a G sensor 10, a wheel sensor 20, an electronic stability control (ESC) 30, and a hill-start assist control (HAC) 40. In particular, the G sensor 10 and the wheel sensor 20 may be configured to simultaneously or sequentially determine a state of a vehicle, and the wheel sensor 20 may be configured to determine a wheel direction of a front wheel or a rear wheel. The ESC 30 may be configured to detect a gradient of the road and a direction of the wheel, which are measured by the G sensor 10 and the wheel sensor 20, respectively, and may be configured to determine whether to operate the HAC 40.

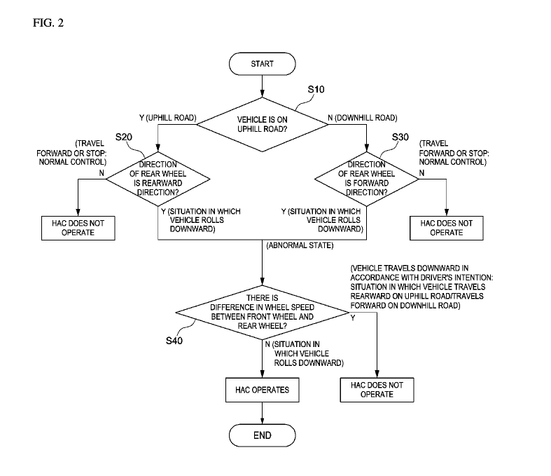

FIG. 2 is a flowchart of the present invention. The method described herein below may be executed by a controller having a processor and a memory. In particular, the method may be executed by an overall controller mounted within the vehicle. Referring to FIG. 2, the method of preventing a vehicle from rolling downward on a hill by using the apparatus 1 illustrated in FIG. 1 may include determining whether the vehicle travels normally or abnormally on a hill based on the gradient measured by the G sensor 10 and a direction of the wheel measured by the wheel sensor 20 (S10 to S30), and determining whether to operate the controller by determining a difference in wheel speed between a front wheel and a rear wheel of the vehicle when the vehicle travels abnormally as the vehicle rolls downward (S40). Further, when the vehicle is determined to be traveling normally in accordance with a driver intention, the controller may be maintained in an off state (e.g., not operated).

The determination of whether the vehicle travels normally or abnormally on the hill (S10 to S30) refers to determining whether the vehicle travels from a current position in a direction intended by the driver. In other words, a normal travel refers to the vehicle moving in an intended direction and abnormal travel refers to the vehicle moving in an unintended direction, such as, rolling backwards down a hill with a forward moving direction intention Accordingly, the controller operates regardless of an inhibitor switch installed in the vehicle, and as a result, the ESC 30 may be configured to operate the controller regardless of whether the inhibitor switch detects a gear shift stage of an automatic transmission. Since the ESC 30 may be configured to operate the controller regardless of the inhibitor switch, it may be possible to prevent the vehicle from rolling downward by operating the controller even without turning on lamps within the vehicle related to a system stop, warning, and the like even though the inhibitor switch is defective or malfunctioning.

Particularly, the controller may be operated based on measuring a wheel direction detected by the wheel sensor 20 based on whether the vehicle is on an uphill road or a downhill road (e.g., incline or decline road). When the vehicle is traveling on an uphill road, the method may include determining, by the G sensor 10, whether the vehicle is on an uphill road or a downhill road, and determining, by the wheel sensor 20, any one of a clockwise direction of the wheel, a counterclockwise direction of the wheel, and a stop of the wheel.

The method may include allowing the controller not to operate (e g , maintaining the controller in an off state) by determining that the vehicle travels normally when a gradient measured by the G sensor 10 is uphill and the wheel moves forward or stops, and determining whether to operate the controller by determining that the travels vehicle abnormally when a gradient measured by the G sensor 10 is uphill and the wheel moves rearward and by determining a difference in wheel speed between the front wheel or the rear wheel of the vehicle. When the vehicle is on the uphill road, if the wheel moves forward or stops, the vehicle may be determined to be traveling upward or stops, and therefore the vehicle may be determined to be traveling normally without rolling backward.

Accordingly, the present control method may terminate without executing the operation of the HAC 40. However, when the wheel moves rearward, the vehicle rolls backward, and in this case, it is necessary to determine once again whether the vehicle travels backward in accordance with the driver's intention. This situation will be described with reference to the determining of the difference in wheel speed.

Furthermore, when the vehicle is determined to be traveling on a downhill road, the method may include maintaining the controller in an off state by determining that the vehicle travels normally when a gradient measured by the G sensor 10 is downhill and the wheel moves rearward or stops, and determining whether to operate the controller by determining that the travels vehicle abnormally when a gradient measured by the G sensor 10 is downhill and the wheel moves forward and by determining a difference in wheel speed between the front wheel and the rear wheel of the vehicle.

When the vehicle is on the downhill road, if the wheel moves rearward or stops, the vehicle may be determined to be traveling upward or stops, and therefore the vehicle may be determined to be traveling normally without rolling forward. Accordingly, the present control method may terminate without executing the operation of the HAC 40. However, when the wheel moves forward, the vehicle rolls backward, and in this case, it is necessary to determine once again whether the vehicle travels backward in accordance with the driver's intention or the vehicle autonomously rolls forward. This situation will be described with reference to the determining of the difference in wheel speed.

When the vehicle is determined to be traveling abnormally, it is necessary to determine whether the vehicle travels in accordance with the driver's intention, and as a result, the method may further include determining a difference in wheel speed between the front wheel and the rear wheel of the vehicle when the vehicle travels abnormally. The difference in wheel speed may be determined after the vehicle stops and then the brake pedal is released. In particular, the determination of the difference in wheel speed between the front wheel and the rear wheel of the vehicle (S40) may be executed in consideration of a speed of a driving wheel being greater than a speed of a non-driven wheel.

The following two cases may be determined according to the exemplary embodiment of the present invention.

When there is the difference in wheel speed when the vehicle is on the uphill road, R-stage driving power may be generated on the front wheel, and therefore the vehicle does not autonomously roll backward but travels backward based on the driver's intention, and as a result, the controller may be maintained in an off state. When there is no difference in wheel speed, the vehicle rolls backward due to creep driving power of the front wheel unable to overcome a vehicle weight even though the current gear shift stage is not a reverse (R) stage but a drive (D) stage, and as a result, the HAC 40 may be configured to operate to hold (e.g., stop) the rear wheel.

When there is the difference in wheel speed when the vehicle is on the downhill road, D-stage driving power may be generated on the front wheel, and therefore the vehicle does not autonomously roll forward but travels forward based on the driver's intention, and as a result, the controller may be maintained in an off state. When there is no difference in wheel speed, the vehicle rolls forward due to the creep driving power of the front wheel unable to overcome the vehicle weight even though the current gear shift stage is not the D stage but the R stage, and as a result, the HAC 40 may be configured to operate to hold the rear wheel.

In the aforementioned processes, the gear shift stage of the automatic transmission may be checked by the inhibitor switch installed in the vehicle, but in the present invention, the controller needs to operate regardless of the inhibitor switch, and as a result, it is necessary to additionally check a difference in wheel speed between the front wheel and the rear wheel when the vehicle travels abnormally. The controller may be any one of the hill-start assist control (HAC) 40, an electronic parking brake (EPB), and an automatic vehicle hold (AVH) which are installed within the vehicle.

While the present invention has been described in detail above with reference to the representative exemplary embodiment, those skilled in the art to which the present invention pertains will understand that the exemplary embodiment may be variously modified without departing from the scope of the present invention. Accordingly, the scope of the present invention should not be limited to the described exemplary embodiment, but should be defined not only by the appended claims but also by all changes or modified forms induced from an equivalent concept to the claims.

What is claimed is:

1. A method of preventing an automatic transmission vehicle from rolling downward on a hill, which operates a controller for preventing the vehicle from rolling downward by using a G sensor and a wheel sensor mounted within the vehicle, the method comprising:
determining whether the vehicle travels normally or abnormally on the hill based on a gradient measured by the G sensor and a direction of a wheel measured by the wheel sensor;
maintaining the controller in an off state when the vehicle travels normally based on a driver intention; and
determining whether to operate the controller by determining a difference in wheel speed between a front wheel and a rear wheel of the vehicle when the vehicle travels abnormally as the vehicle rolls downward.

2. The method of claim 1, wherein the controller operates regardless of an inhibitor switch installed within the vehicle.

3. The method of claim 1, further comprising:
determining, by the G sensor, whether the vehicle is on an uphill road or a downhill road; and
determining, by the wheel sensor, any one of a forward direction of the wheel, a rearward direction of the wheel, and a stop of the wheel.

4. The method of claim 3, further comprising:
maintaining the controller in an off state by determining that the vehicle travels normally when a gradient measured by the G sensor is uphill and the wheel travels forward or stops; and
determining whether to operate the controller by determining that the vehicle travels abnormally when a gradient measured by the G sensor is uphill and the wheel moves rearward and by determining a difference in wheel speed between the front wheel and the rear wheel of the vehicle.

5. The method of claim 3, further comprising:
maintaining the controller in an off state by determining that the vehicle travels normally when a gradient measured by the G sensor is downhill and the wheel moves rearward or stops; and
determining whether to operate the controller by determining that the vehicle abnormally travels when a gradient measured by the G sensor is downhill and the wheel moves forward and by determining a difference in wheel speed between the front wheel and the rear wheel of the vehicle.

6. The method of claim 1, further comprising:
determining a difference in wheel speed between the front wheel and the rear wheel of the vehicle when the vehicle travels abnormally,
wherein the difference in wheel speed is determined after the vehicle stops and then a brake pedal is released.

7. The method of claim 1, wherein the controller is any one of a hill-start assist control (HAC), an electronic parking brake (EPB), and an automatic vehicle hold (AVH) which are installed in the vehicle.

8. A system of preventing an automatic transmission vehicle from rolling downward on a hill, comprising:
a G sensor configured to determine whether the vehicle is on an uphill road or a downhill road;
a wheel sensor configured to determine a wheel direction or a front wheel or a rear wheel of the vehicle; and
a controller configured to operate based on determining a difference in wheel speed between the front wheel and the rear wheel of the vehicle when the vehicle travels abnormally as the vehicle rolls downward.

9. The system of claim 8, wherein the G sensor and the wheel sensor are configured to simultaneously or sequentially determine a state of the vehicle.

10. The system of claim 8, wherein the wheel sensor is configured to determine any one of a forward direction of a vehicle wheel, a rearward direction of the vehicle wheel, and a stop of the vehicle wheel.
